(19) United States
(12) Patent Application Publication
(10) Pub. No.: US 2011/0241967 A1
(43) Pub. Date: Oct. 6, 2011

(54) Antenna Assemblies For Use With Portable Communications Devices

(75) Inventors: Andrei Kaikkonen, Jarfalla (SE); Peter Lindberg, Uppsala (SE)

(73) Assignee: LAIRD TECHNOLOGIES AB, Kista (SE)

(21) Appl. No.: 13/162,203

(22) Filed: Jun. 16, 2011

Related U.S. Application Data
(63) Continuation-in-part of application No. PCT/IB2009/007320, filed on Nov. 4, 2009.
(60) Provisional application No. 61/139,615, filed on Dec. 21, 2008.
(60) Provisional application No. 61/139,882, filed on Dec. 22, 2008.

(51) Int. Cl. H01Q 1/52

(52) U.S. Cl. 343/851

(57) ABSTRACT

An antenna assembly generally includes an antenna element, an amplifier, and an electronics protection system coupled generally between the antenna element and the amplifier. In operation, the electronics protection system may filter cross-talk, protect against electrostatic discharge, and/or suppress radiated spurious emissions. The electronics protection system may include first and second inductors disposed in series generally between the antenna element and the amplifier. First and second diodes may be disposed generally between the first and second inductors.

### CROSS-REFERENCE TO RELATED APPLICATIONS

This application is continuation-in-part of PCT International Application PCT/IB2009/007320 filed Nov. 4, 2009 (now published as WO 2010/070401) which, in turn, claims priority to and the benefit of U.S. Provisional Patent Application No. 61/139,615 filed Dec. 21, 2008 and U.S. Provisional Patent Application No. 61/139,882 filed Dec. 22, 2008. The entire disclosures of the above applications are incorporated herein by reference.

### FIELD

The present disclosure relates generally to antenna assemblies suitable for use with portable communications devices, and more particularly to antenna assemblies having systems for suppressing, for example, electrostatic discharge and/or radiated spurious emissions.

### BACKGROUND

This section provides background information related to the present disclosure which is not necessarily prior art.

Portable communications devices operable for providing multiple different modes of operation are becoming increasingly prevalent. For example, mobile phones may commonly support, among other modes of operation, voice communication modes over the Global System for Mobile communications (GSM) system, wireless local area network (WLAN) connection modes, and Bluetooth communication modes.

While these devices are very useful, the wireless modes used by such devices can cause mutual interference between modes of operation. For example, Bluetooth communications and spur harmonics from some GSM channels can interfere with the WLAN connections; WLAN transmitters can interfere with GSM receivers; GSM transmitters can interference with WLAN receivers; etc. Unfortunately, this interference can significantly inhibit the operational effectiveness of these devices.

### SUMMARY

This section provides a general summary of the disclosure, and is not a comprehensive disclosure of its full scope or all of its features.

The present disclosure relates generally to antenna assemblies suitable for use with portable communications devices, and more particularly to systems for filtering cross-talk, protecting against electrostatic discharge, and/or suppressing radiated spurious emissions in an antenna assembly. In an exemplary embodiment, an electronics protection system may include first and second inductors disposed in series generally between the antenna element and the amplifier. First and second diodes may be disposed generally between the first and second inductors.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a functional block diagram of an example portable communications device having an antenna assembly with a system (e.g., electronics protection system or circuit, etc.) according to an example embodiment of the present disclosure operable for filtering cross-talk, for protecting against electrostatic discharge, and/or for suppressing radiated spurious emissions within the portable communications device;

FIG. 2 is a functional block diagram of an example portable communications device having an antenna assembly with a half-loop antenna element and with a system (e.g., electronics protection system or circuit, etc.) according to another example embodiment of the present disclosure operable for filtering cross-talk, for protecting against electrostatic discharge, and/or for suppressing radiated spurious emissions within the portable communications device;

FIG. 3 is a functional block diagram of an example portable communications device having an antenna assembly with a monopole antenna element and with a system (e.g., electronics protection system or circuit, etc.) according to another example embodiment of the present disclosure operable for filtering cross-talk, for protecting against electrostatic discharge, and/or for suppressing radiated spurious emissions within the portable communications device;

FIG. 4 is a line graph illustrating in-band gain for frequency modulation applications for an antenna assembly having an electronics protection system according to the present disclosure and for an antenna assembly not having such an electronics protection system;

FIG. 5 is a functional block diagram of an example portable communications device having an antenna assembly with a system (e.g., electronics protection system or circuit, etc.) that includes parasitic capacitance in or associated with each of the two illustrated inductors according to another example embodiment of the present disclosure, which system is operable for filtering cross-talk, for protecting against electrostatic discharge, and/or for suppressing radiated spurious emissions within the portable communications device; and

FIG. 6 is a line graph illustrating impedance magnitude (in ohms) versus frequency (in Gigahertz) for each and both inductors of the antenna assembly shown in FIG. 5.

Corresponding reference numerals indicate corresponding parts throughout the several views of the drawings.

### DETAILED DESCRIPTION

Example embodiments will now be described more fully with reference to the accompanying drawings.

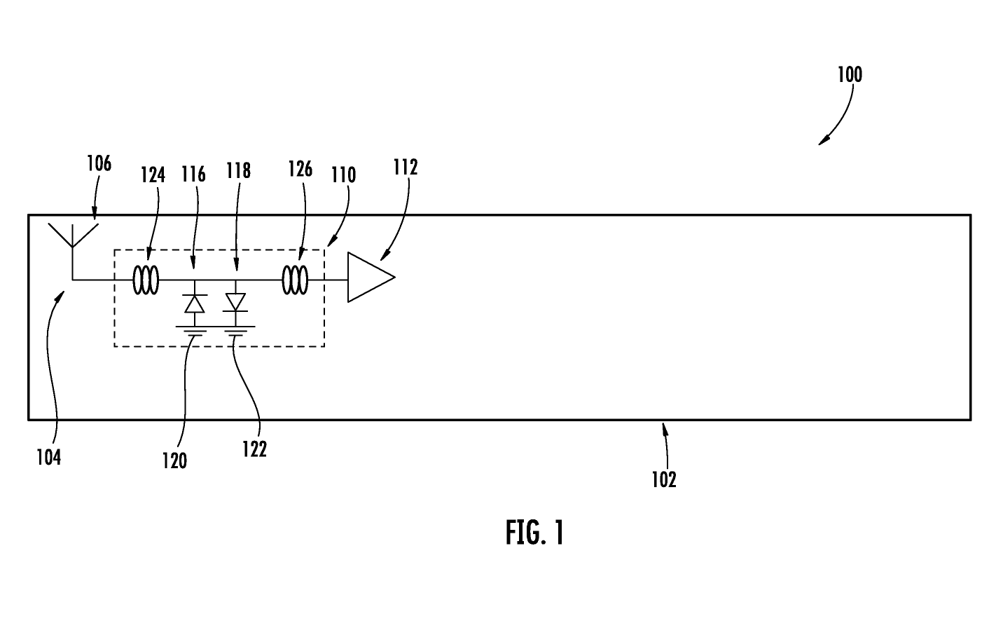

Referring now to the drawings, FIG. 1 illustrates a functional block diagram of an example portable communications device 100 including one or more aspects of the present disclosure. As will be described in further detail hereinafter, the illustrated portable communications device 100 includes at least one or more features or means (e.g., filter solutions, etc.) for filtering cross-talk (e.g., from GSM/Bluetooth interactions, etc.); and/or for protecting against, suppressing, filtering, etc. electrostatic discharge (ESD), and/or for protecting against, suppressing, filtering, etc. radiated spurious emission (RSE) with little or no compromise to performance of the device 100 (e.g., with little or no efficiency loss to frequency modulation (FM); with little or no signal attenuation; with little or no thermal noise addition; etc.). The portable communications device 100 may include, for example, a cellular phone, a personal digital assistant (PDA), a global positioning system (GPS), a media device, other electronic devices, etc. within the scope of the present disclosure.

As shown in FIG. 1, the illustrated portable communications device 100 generally includes a body or housing 102 and an antenna assembly 104 supported by or housed within the body or housing 102. For example, the antenna assembly 104 may be coupled to the body 102 by any suitable means known in the art.

The antenna assembly 104 generally includes an antenna element 106 (e.g., a radiator, etc.), an amplifier 112, and an electronics protection system or means 110 positioned or interposed generally between the antenna element 106 and the amplifier 112. As will be described in more detail hereinafter, the electronics protection system 110 includes a circuit configuration operable to filter cross-talk, protect against ESD, and/or suppress RSE generally within the portable communications device 100, with little or no compromise to performance of the device 100. The antenna assembly 104 may include one or more additional components as desired within the scope of the present disclosure, such as, for example, capacitors (e.g., one or more DC-blocking capacitors disposed adjacent the amplifier 112, antenna element matching capacitors, etc.), inductors (e.g., antenna element matching inductors, etc.), receivers (e.g., FM receivers, etc.), etc.

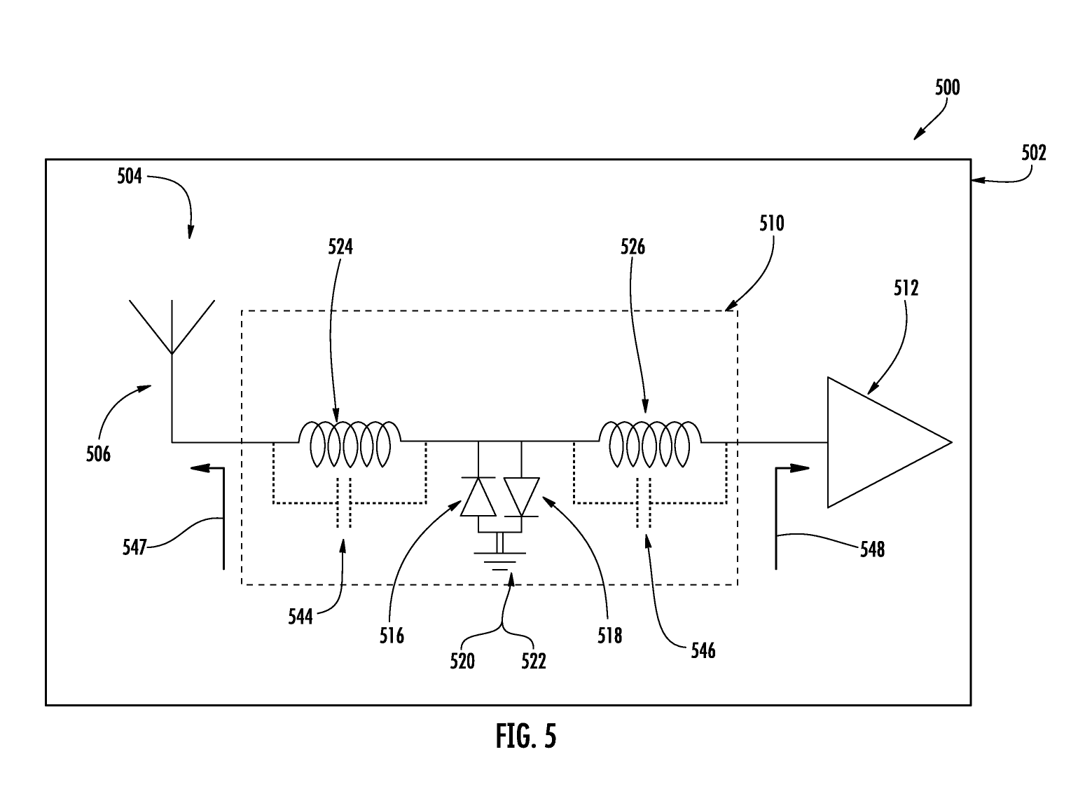

In the illustrated embodiment of FIG. 1 and other embodiments (e.g., FIG. 5, etc.), the antenna assembly 104 may include one or more suitable antenna elements configured to be operable in one or multiple operating frequency bands, such as frequency bandwidths associated with FM, WLAN, Bluetooth, GSM (e.g., GSM 850, GSM 900, GSM 1800, GSM 1900), Universal Mobile Telecommunications System (UMTS), Advanced Mobile Phone System (AMPS), Wi-Fi (e.g., Wi-Fi 2400, Wi-Fi 5000), etc. The antenna assembly 104 may, for example, include one or more half-loop antenna elements, monopole antenna elements, etc. within the scope of the present disclosure. For example, antenna elements may include generally electrically short antenna elements (e.g., as compared to a free-space wavelength of the antenna elements, etc.) with high impedances in the one or multiple operating frequency bands of the portable communications devices in which they are included (e.g., the FM operating frequency band, etc.). The generally electrically short antenna elements can have high impedances as a result of, for example, physical or natural properties of the antenna elements (e.g., monopole antenna elements with relatively short actual physical lengths, etc.); being coupled in parallel (e.g., anti-resonant, etc.) shunt configurations with inductors (e.g., for short monopole antenna elements, etc.); being coupled in parallel shunt configurations with capacitors (e.g., for short half-loop antenna elements, etc.); being coupled in parallel shunt configurations with LC resonators (e.g., operated slightly above the operating frequency bands of the wireless systems (e.g., the FM operating frequency band, etc.) and, together with the antenna elements, made resonant in the center of the operating frequency bands of the wireless systems); etc. High impedance antenna elements may also include electrically short monopole resonated/loaded/reactance compensated by half-loop antenna elements, and electrically short half-loop resonated/loaded/reactance compensated by monopole antenna elements. By way of further example, the antenna elements may include magnetic and/or electric types of small active antennas, such as electrically small antennas where the radiation resistance is, by necessity, in the mΩ range (meaning that a 2Ω matching network resistance instead of 1Ω drops 3 dB of efficiency. For comparison, both 1Ω or 2Ω (or 10Ω) loss in a normal 50Ω system does not contribute significantly to the system performance).

The amplifier 112 may include any suitable amplifier (e.g., regardless of transistor technology, etc.), for example, a high impedance low noise amplifier (LNA), such as a monolithic microwave integrated circuit (MMIC) LNA, bipolar junction transistor (BJT) LNA, heterojunction bipolar transistor (HBT) LNA, field effect transistor (FET) LNA, complementary metal-oxide semiconductor (CMOS) LNA, etc. within the scope of the present disclosure. And, the amplifier 112 can be coupled to the antenna element 106 via the electronics protection system 110 as desired. In other example embodiments, portable communications devices may include more than one amplifier within the scope of the present disclosure.

The illustrated electronics protection system 110 generally includes first and second anti-parallel diodes 116 and 118 (e.g., Schottky diodes, ESD diodes, etc.) coupled to grounds 120 and 122, respectively, without any intervening components (e.g., inductors, capacitors, etc.) between the diodes 116 and 118. The electronics protection system 110 also includes first and second inductors 124, 126 disposed in series generally between the antenna element 106 and the amplifier 112.

The first inductor 124 is located generally adjacent the antenna element 106. The second inductor 126 is located generally adjacent the amplifier 112. Stated differently, the first inductor 124 is closer to the antenna element 106 than is the second inductor 126, which, in turn, is closer to the amplifier 112 than is the first inductor 124. Accordingly, the first inductor 124 is between the antenna element 106 and second inductor 126, whereas the second inductor 126 is between the amplifier 112 and the first inductor 124. Also in this illustrated embodiment, there are no intervening components or circuits (e.g., capacitors, inductors, matching circuits, etc.) directly between the first inductor 124 and antenna element 106. Likewise, there are intervening components or circuits (e.g., capacitors, inductors, matching circuits, etc.) directly between the second inductor 126 and amplifier 112. In other embodiments, one or more components and/or circuits may be interposed or positioned between the first inductor 124 and antenna element 106 and/or between the second inductor 126 and amplifier 112.

The first and second anti-parallel diodes 116 and 118 are generally coupled in shunt at a location generally between the first and second inductors 124 and 126. In the illustrated embodiment, the electronics protection system 110 is thus generally bound on both sides by high impedance components (e.g., the antenna element 106 on one side and the amplifier 112 on the other side, etc.) within the operating frequency band of the portable communications device 100. Also in the illustrated embodiment, the first and/or second inductors 124 and/or 126 may provide inductance operation values of about 50 nanoHenries (nH) to about 100 nH. By way of example only, the first inductor 124 may provide inductance operation values of about 50 nH to about 100 nH, and the second inductor 126 may provide inductance operation values of about 91 nH. However, it should be appreciated that inductors providing other inductance operation values may be used within the scope of the present disclosure.

In operation of the electronics protection system 110, the first and second anti-parallel diodes 116 and 118 operate to provide ESD protection for the amplifier 112. More particularly, the anti-parallel diodes 116 and 118 operate to short unwanted voltages (e.g., both positive and negative voltages, etc.) associated with ESD to grounds 120 and 122. And, the first inductor 124 operates (with minimal losses or at least reduced losses) to suppress unwanted high frequency signals from reaching the first and second anti-parallel diodes 116 and 118, and to suppress unwanted spur harmonics generated by the first and second anti-parallel diodes 116 and 118 (e.g., spur harmonics associated with harmonic frequency content generated by non-linearities in the anti-parallel diodes 116 and 118 caused by GSM/Bluetooth interactions, etc.) from, for example, radiating to the antenna element 106, etc. And, the second inductor 126 operates (with minimal losses or at least reduced losses) to suppress unwanted high frequency signals from GSM or Bluetooth interactions, or the high frequency content of ESD pulses, from, for example, reaching the amplifier 112, etc.

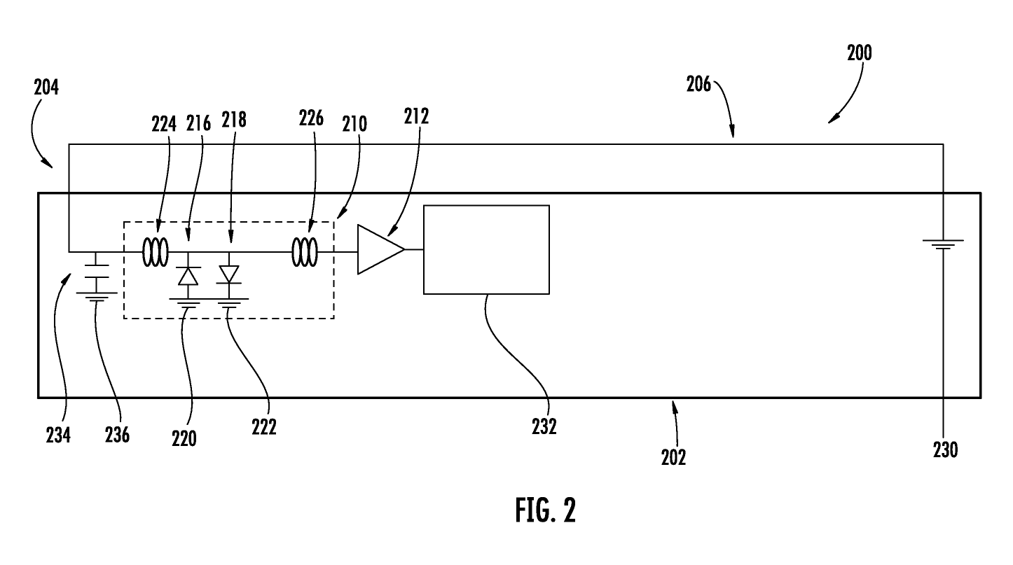

FIG. 2 illustrates a functional block diagram of another example portable communications device 200 including one or more aspects of the present disclosure. As will be described in further detail hereinafter, the illustrated portable communications device 200 includes at least one or more features allowing for filtering cross-talk, and/or for protecting against ESD, and/or for suppressing RSE with little or no compromise to performance of the device 200.

As shown in FIG. 2, the illustrated portable communications device 200 generally includes a body 202 and an antenna assembly 204 coupled to the body 202. The illustrated antenna assembly 204 generally includes a low impedance half-loop antenna element 206 converted to high impedance by matching capacitor 234. A first end portion of the half-loop antenna element 206 is grounded (e.g., coupled to the body 202 of the portable communications device 200, etc.) at 230 (as is generally known in the art), and a second end portion of the half-loop antenna element 206 is coupled to a frequency modulation (FM) receiver 232.

The illustrated portable communications device 200 also generally includes a high impedance low noise amplifier (LNA) 212 adjacent the FM receiver 232 and a matching capacitor 234 coupled to ground 236. The LNA 212 operates to amplify signals received by the antenna element 206 and transmitted to the FM receiver 232. And, the matching capacitor 234 operates to provide, for example, impedance matching (e.g., high impedance and parallel resonance together with the half-loop antenna element 206, etc.) for the antenna assembly 204 (e.g., for the half-loop antenna element 206 of the antenna assembly 204, etc.), etc.

The illustrated antenna assembly 204 further generally includes an electronics protection system 210 operable for providing cross-talk filtering to and/or ESD protection to and/or RSE suppression for the antenna assembly 204. In the illustrated embodiment, the electronics protection system 210 is disposed generally within the portable communications device 200 between the matching capacitor 234 and the LNA 212, generally where the second end portion of the antenna element 206 couples to the LNA 212 and FM receiver 232.

The illustrated electronics protection system 210 generally includes first and second anti-parallel diodes 216 and 218 (e.g., Schottky diodes, ESD diodes, etc.) coupled to grounds 220 and 222, respectively, without any intervening components (e.g., inductors, capacitors, etc.) between the diodes 216 and 218. A first inductor 224 is located adjacent the matching capacitor 234. A second inductor 226 is located adjacent the LNA 212. Stated differently, the first inductor 224 is closer to the matching capacitor 234 than is the second inductor 226, which, in turn, is closer to the LNA 212 than is the first inductor 224. Accordingly, the first inductor 224 is between the matching capacitor 234 and second inductor 226, whereas the second inductor 226 is between the LNA 212 and the first inductor 224.

And, the first and second anti-parallel diodes 216 and 218 are disposed generally between the first and second inductors 224 and 226 (e.g., substantially where the antenna element 206 couples to the LNA 212 and FM receiver 232, etc.). The first and second anti-parallel diodes 216 and 218 are generally coupled in shunt and are disposed generally in parallel with the matching capacitor 234. In the illustrated embodiment, the first and/or second inductors 224 and/226 may provide inductance operation values of about 50 nH to about 100 nH. By way of example only, the first inductor 224 may provide inductance operation values of about 50 nH to about 100 nH, and the second inductor 226 may provide inductance operation values of about 91 nH. However, it should be appreciated that inductors providing other inductance operation values may be used within the scope of the present disclosure.

It should be appreciated that the portable communications device 200 may also include one or more DC-blocking capacitors disposed adjacent the LNA 212 and/or FM receiver 232 as desired (and as generally known in the art). For example, a DC-blocking capacitor may be disposed generally between the second inductor 226 of the electronics protection system 210 and the LNA 212 and/or between the LNA 212 and the FM receiver 232 within the scope of the present disclosure.

In operation of the electronics protection system 210, the first and second anti-parallel diodes 216 and 218 operate to provide ESD protection for the LNA 212. More particularly, the anti-parallel diodes 216 and 218 operate to short unwanted voltages (e.g., both positive and negative voltages, etc.) associated with ESD to grounds 220 and 222. The first inductor 224 operates to suppress unwanted high frequency signals from reaching the first and second anti-parallel diodes 216 and 218, and to suppress unwanted spur harmonics generated by the first and second anti-parallel diodes 216 and 218 (e.g., spur harmonics associated with harmonic frequency content generated by non-linearities in the anti-parallel diodes 216 and 218 caused by GSM/Bluetooth interactions, etc.) from, for example, radiating to the matching capacitor 234, etc. And, the second inductor 226 operates to suppress unwanted high frequency signals from GSM or Bluetooth interactions, or the high frequency content of ESD pulses, from, for example, reaching the LNA 212 and FM receiver 232, etc.

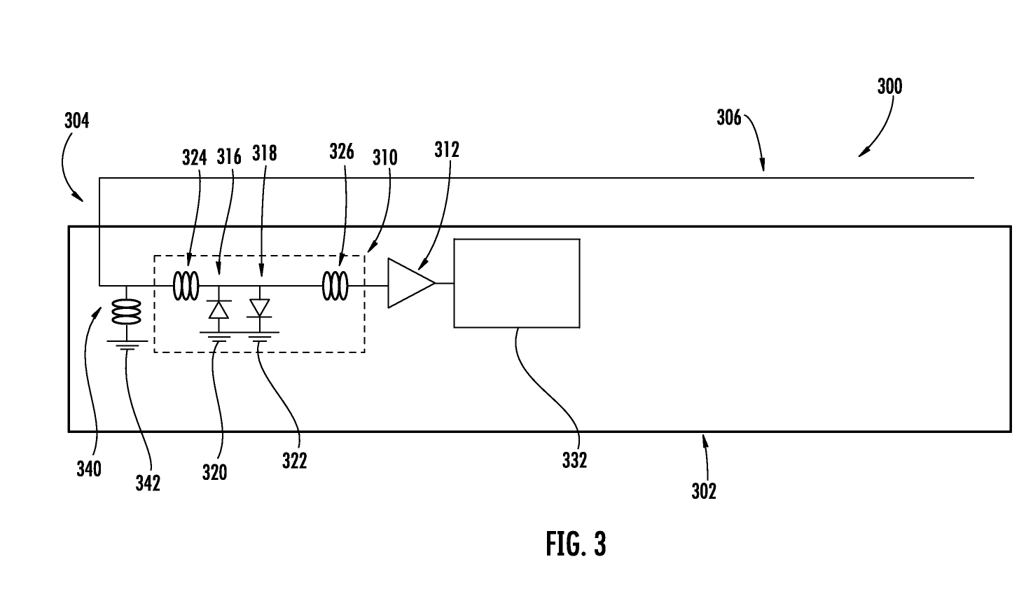

FIG. 3 illustrates a functional block diagram of another example portable communications device 300 including one or more aspects of the present disclosure. As will be described in further detail hereinafter, the illustrated portable communications device 300 includes at least one or more features allowing for filtering cross-talk, and/or for protecting against ESD, and/or for suppressing RSE with little or no compromise to performance of the device 300.

As shown in FIG. 3, the illustrated portable communications device 300 generally includes a body 302 and an antenna assembly 304 coupled to the body 302. The illustrated antenna assembly 304 generally includes a high impedance monopole antenna element 306. In this embodiment, a second end portion of the monopole antenna element 306 is coupled to a frequency modulation (FM) receiver 332.

The illustrated portable communications device 300 also generally includes a high impedance LNA 312 adjacent the FM receiver 332 and a matching inductor 340 coupled to ground 342. The LNA 312 operates to amplify signals received by the antenna element 306 and transmitted to the FM receiver 332. And, the matching inductor 340 operates to provide, for example, impedance matching (e.g., high impedance and parallel resonance together with the monopole antenna element 306, etc.) for the antenna assembly 304 (e.g., for the monopole antenna element 306 of the antenna assembly 304, etc.), etc.

The illustrated antenna assembly 304 further generally includes an electronics protection system 310 operable for providing cross-talk filtering to and/or ESD protection to and/or RSE suppression for the antenna assembly 304. In the illustrated embodiment, the electronics protection system 310 is disposed generally within the portable communications device 300 between the matching inductor 340 and the LNA 312, generally where the second end portion of the antenna element 306 couples to the LNA 312 and FM receiver 332.

The illustrated electronics protection system 310 generally includes first and second anti-parallel diodes 316 and 318 (e.g., Schottky diodes, ESD diodes, etc.) coupled to grounds 320 and 322, respectively, without any intervening components (e.g., inductors, capacitors, etc.) between the diodes 316 and 318. A first inductor 324 is located adjacent the matching inductor 340. A second inductor 326 is located adjacent the LNA 312. Stated differently, the first inductor 324 is closer to the matching inductor 340 than is the second inductor 326, which, in turn, is closer to the LNA 312 than is the first inductor 324. Accordingly, the first inductor 324 is between the matching inductor 340 and second inductor 326, whereas the second inductor 326 is between the LNA 312 and the first inductor 324.

And, the first and second anti-parallel diodes 316 and 318 are disposed generally between the first and second inductors 324 and 326 (e.g., substantially where the antenna element 306 couples to the LNA 312 and FM receiver 332, etc.). The first and second anti-parallel diodes 316 and 318 are generally coupled in shunt and are disposed generally in parallel with the matching inductor 340. In the illustrated embodiment, the first and/or second inductors 324 and/326 may provide inductance operation values of about 50 nH to about 100 nH. By way of example only, the first inductor 324 may provide inductance operation values of about 50 nH to about 100 nH, and the second inductor 326 may provide inductance operation values of about 91 nH. However, it should be appreciated that inductors providing other inductance operation values may be used within the scope of the present disclosure.

It should be appreciated that the portable communications device 300 may also include one or more DC-blocking capacitors disposed adjacent the LNA 312 and/or FM receiver 332 as desired (and as generally known in the art). For example, a DC-blocking capacitor may be disposed generally between the second inductor 326 of the electronics protection system 310 and the LNA 312 and/or between the LNA 312 and the FM receiver 332 within the scope of the present disclosure.

In operation of the electronics protection system 310, the first and second anti-parallel diodes 316 and 318 operate to provide ESD protection for the LNA 312. More particularly, the anti-parallel diodes 316 and 318 operate to short unwanted voltages (e.g., both positive and negative voltages, etc.) associated with ESD to grounds 320 and 322. The first inductor 324 operates to suppress unwanted high frequency signals from reaching the first and second anti-parallel diodes 316 and 318, and to suppress unwanted spur harmonics generated by the first and second anti-parallel diodes 316 and 318 (e.g., spur harmonics associated with harmonic frequency content generated by non-linearities in the anti-parallel diodes 316 and 318 caused by GSM/Bluetooth interactions, etc.) from, for example, radiating to the matching inductor 340, etc. And, the second inductor 326 operates to suppress unwanted high frequency signals from GSM or Bluetooth interactions, or the high frequency content of ESD pulses, from, for example, reaching the LNA 312 and FM receiver 332, etc.

FIG. 5 illustrates a functional block diagram of another example portable communications device 500 including one or more aspects of the present disclosure. As will be described in further detail hereinafter, the illustrated portable communications device 500 includes at least one or more features allowing for filtering cross-talk, and/or for protecting against ESD, and/or for suppressing RSE with little or no compromise to performance of the device 500.

As shown in FIG. 5, the illustrated portable communications device 500 generally includes a body or housing 502 and an antenna assembly 504 coupled to or housed within the body or housing 502. The antenna assembly 504 generally includes an antenna element 506 (e.g., a radiator, etc.), an amplifier 512, and an electronics protection system 510 positioned or interposed generally between the antenna element 506 and the amplifier 512.

The antenna assembly 504 may include one or more suitable antenna elements such as, for example, half-loop antenna elements, monopole antenna elements, etc. within the scope of the present disclosure. For example, antenna elements may include generally electrically short antenna elements (e.g., as compared to a free-space wavelength of the antenna elements, etc.) with high impedances in the operating frequency bands of the portable communications devices in which they are included (e.g., the FM operating frequency band, etc.). In the illustrated embodiment of FIG. 5, the arrows 547 and 548 generally represent the high impedance at the FM operating frequency band.

The amplifier 512 may include any suitable amplifier (e.g., regardless of transistor technology, etc.), for example, a high impedance low noise amplifier (LNA), such as a monolithic microwave integrated circuit (MMIC) LNA, bipolar junction transistor (BJT) LNA, heterojunction bipolar transistor (HBT) LNA, field effect transistor (FET) LNA, complementary metal-oxide semiconductor (CMOS) LNA, etc. within the scope of the present disclosure. And, the amplifier 512 can be coupled to the antenna element 506 via the electronics protection system 510 as desired. In other example embodiments, portable communications devices may include more than one amplifier within the scope of the present disclosure.

With further regard to the electronics protection system 510, it generally includes a circuit configuration operable to filter cross-talk, protect against ESD, and/or suppress RSE generally within the portable communications device 500, with little or no compromise to performance of the device 500. The antenna assembly 504 may include one or more additional components as desired within the scope of the present disclosure, such as, for example, capacitors (e.g., one or more DC-blocking capacitors disposed adjacent the amplifier 512, antenna element matching capacitors 234, etc.), inductors (e.g., antenna element matching inductors 340, etc.), receivers (e.g., FM receivers 232, 332, etc.), etc.

In this particular embodiment illustrated in FIG. 5, the electronics protection system or circuit 510 includes first and second anti-parallel diodes 516 and 518 (e.g., Schottky diodes, ESD diodes, etc.) coupled to grounds 520 and 522, respectively, without any intervening components (e.g., inductors, capacitors, etc.) between the diodes 516 and 518. The electronics protection system 510 also includes first and second inductors 524 and 526. This particular embodiment also includes parasitic capacitance 544, 546 associated with each inductor 524, 526, respectively, as discussed below.

With continued reference to FIG. 5, the first inductor 524 is located generally adjacent the antenna element 506, and the second inductor 526 is located generally adjacent the amplifier 512. Stated differently, the first inductor 524 is closer to the antenna element 506 than is the second inductor 526, which, in turn, is closer to the amplifier 512 than is the first inductor 524. Accordingly, the first inductor 524 is between the antenna element 506 and second inductor 526, whereas the second inductor 526 is between the amplifier 512 and the first inductor 524.

The first and second anti-parallel diodes 516 and 518 are generally coupled in shunt at a location generally between the first and second inductors 524 and 526. In the illustrated embodiment, the electronics protection system 510 is thus generally bound on both sides by high impedance components (e.g., the antenna element 506 on one side and the amplifier 512 on the other side, etc.) within the operating frequency band of the portable communications device 500. Also in the illustrated embodiment, the first and/or second inductors 524 and/or 526 may provide inductance operation values of about 50 nanoHenries (nH) to about 100 nH. By way of example only, the first inductor 524 may provide inductance operation values of about 56 nH, and the second inductor 526 may provide inductance operation values of about 100 nH. However, it should be appreciated that inductors providing other inductance operation values may be used within the scope of the present disclosure.

As noted above, parasitic capacitance 544, 546 is associated with each inductor 524, 526, respectively. In FIG. 5, the dashed lines 544 and 546 indicate the parasitic effects. In an exemplary embodiment, each inductor 524, 526 is configured to have parasitic capacitance 544, 546. For example, this capacitance 544, 546 may be provided or formed by closely spaced windings of the inductors 524, 526, respectively. By the inventors' careful selection of inductor type and value, the second inductor 526 may be self-resonant around GSM 850/900 Tx (or transmission), and the first inductor 524 may be self-resonant around GSM 1800/1900 Tx (or transmission) as discussed below. When connected in series, the two inductors 524, 526 provide a frequency response that is high-impedance in both bands.

The inventors have recognized that using inductors configured to have parasitic capacitance as explained above advantageously allows the overall component count to be reduced. It also helps ensure that each inductance value is maximized (or increased), which, in turn, maximizes (or increases) the bandwidth over which the inductor having parasitic capacitance is high-impedance. Even so, alternative embodiments may instead include first and second capacitors may be coupled to the respective first and second inductors 524, 526 to provide the capacitance associated with each inductor.

In an example embodiment, the inductor 526 closest to the low noise amplifier 512 may be a 100 nH inductor of LQG-type (or equivalent) having a self-resonance close to GSM 850/900 Tx (transmission) bands and that provides strong suppression of GSM 850/900 cross-talk. Continuing with this example embodiment, the inductor 524 closest to the antenna 506 may be a 56 nH inductor of LQW-type (or equivalent) having a self-resonance close to GSM 1800/1900 Tx (transmission) bands and that provides strong suppression of GSM 1800/1900 cross-talk while preventing (or at least inhibiting) harmonics of GSM 850/900 created by the diodes 516, 518 from being radiated. Also in this example embodiment, this arrangement of the 56 nH inductor 524, diodes 516, 518, 100 nH inductor 526, and parasitic capacitance 544, 546 filters and clamps ESD voltages, while being transparent (low impedance) at FM frequencies.

In operation of the electronics protection system 510, the first and second anti-parallel diodes 516 and 518 operate to provide ESD protection for the amplifier 512. More particularly, the anti-parallel diodes 516 and 518 operate to short unwanted voltages (e.g., both positive and negative voltages, etc.) associated with ESD to grounds 520 and 522. And, the first inductor 524 operates (with minimal losses or at least reduced losses) to suppress unwanted high frequency signals (e.g., suppression of GSM 1800/1900 cross-talk, etc.) from reaching the first and second anti-parallel diodes 516 and 518, and to suppress unwanted spur harmonics generated by the first and second anti-parallel diodes 116 and 118 (e.g., spur harmonics associated with harmonic frequency content generated by non-linearities in the anti-parallel diodes 516 and 518 caused by GSM 850/900 and Bluetooth interactions, etc.) from, for example, radiating to the antenna element 506, etc. And, the second inductor 526 operates (with minimal losses or at least reduced losses) to suppress unwanted high frequency signals (e.g., GSM 850/900 cross-talk, from GSM or Bluetooth interactions, etc.) or the high frequency content of ESD pulses from, for example, reaching the amplifier 512, etc.

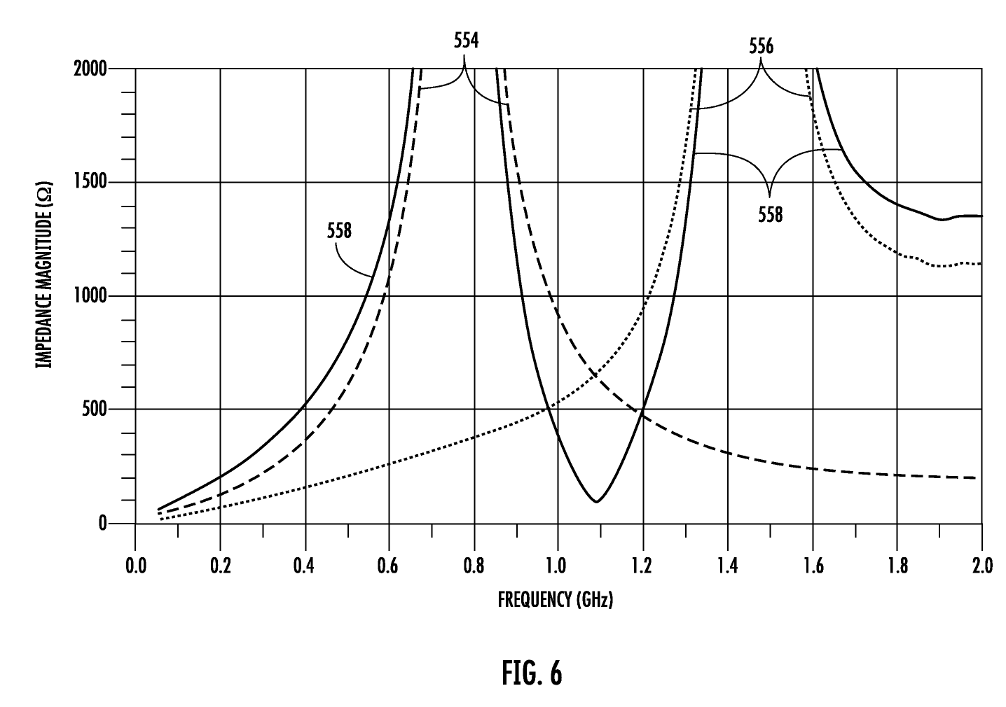

Operational features relating to the inductors 524, 526 of the electronics protection system 510 is generally shown in FIG. 6, which is a line graph illustrating impedance magnitude (in ohms) versus frequency (in Gigahertz) for each inductor 524, 526 and for both inductors 524, 526. In FIG. 6, line 554 represents the impedance magnitude of the first inductor 524 when it has an inductance of 56 nH. In this example, line 554 shows that the 56 nH inductor is self-resonant (and has maximum impedance) at around 1500 Megahertz, and therefore provides a very high impedance (>1000 Ohms) up to at least 2000 Megahertz, thereby suppressing cross-talk from a cellular antenna in the frequency range 1500 Megahertz to 2000 Megahertz. Also in this particular example, the 56 nH inductor blocks GSM1800/1900 and also prevents harmonics created by the diodes (from e.g. GSM850/900 cross-talk) from being radiated by the antenna element.

Line 556 in FIG. 6 represents the impedance magnitude of the second inductor 526 when it has an inductance of 100 nH. In this example, line 556 shows that the 100 nH inductor is self-resonant (and has maximum impedance) at around 800 Megahertz, and provides a very high impedance (>1000 Ohm) in the range 600 Megahertz to 1000 Megahertz. Also in this particular example, the 100 nH inductor blocks GSM850/900.

Line 558 in FIG. 6 represents the impedance magnitude of both the 56 nH inductor and the 100 nH inductor in series. As can be seen by line 558, the circuit is high impedance at GSM850/900+GSM1800/1900, and low impedance (or transparent) at FM frequencies. Line 558 thus shows the total frequency response, in terms of filtering, from the protection circuit shown in FIG. 5. In this example, this filtering both suppresses cross-talk from the cellular antenna, and also suppresses most of the energy in the electrostatic discharge pulse (which is located at around 1 Gigahert). In addition to this filtering effect provided by the 56 nH and 100 nH inductors, the diode pair in anti-parallel configuration also clamps part of the electrostatic discharge pulse that is not suppressed by the filtering provided by the inductors.

In another example embodiment of the present disclosure, a portable communications device is configured to support FM, Bluetooth, and WLAN modes. In this embodiment, 0 dBm power at 2.4 gigahertz (GHz) was fed to an antenna element of the device without anti-parallel diodes of an electronics protection system of the device affecting the Bluetooth efficiency of the device, and without the Bluetooth cross-talk affecting FM sensitivity. In this example, dBm indicates power measurement relative to 1 milliwatt such that 0 dBm means no change from 1 milliwatt and thus 0 dBm is the power level corresponding to a power of exactly 1 milliwatt.

It should be appreciated that in the illustrated antenna assemblies (e.g., 104, 204, 304, 504, etc.) of the present disclosure, the inductors (e.g., 124 and 126, 224 and 226, 324 and 326, 524 and 526, etc.) (e.g., the low quality factor (Q) components, etc.) of the electronics protection systems (e.g., 110, 210, 310, 510, etc.) are located in generally high impedance nodes (e.g., between the antenna elements (e.g., 106, 206, 306, 506, etc.) and amplifiers (e.g., 112, 212, 312, 512, etc.) at FM frequencies, thereby effectively canceling their impact on the noise properties of the amplifiers (e.g., 112, 212, 312, 512, etc.). This can help provide for antenna matching, ESD protection, RSE suppression (e.g., cancelation, etc.), and reductions of (e.g., filtering of, etc.) electromagnetic (EM) cross-talk, with little or no negative impact on antenna assembly performance. For example, the electronics protection systems (e.g., 110, 210, 310, 510, etc.) of the present disclosure may provide protection against, for example, multiple human body model (HBM) pulses of upwards of about 8 kilovolts (kV) discharged at the antenna elements (e.g., 106, 206, 306, 506, etc.) without failure. Moreover, the illustrated electronics protection systems (e.g., 110, 210, 310, 510, etc.) can filter high-frequency signals coupled from nearby high-power transmitters (e.g. cellular antennas, etc.) from reaching, for example, the amplifiers (e.g., 112, 212, 312, 512, etc.) and/or the FM receivers (e.g., 232, 332, etc.), etc.

It should also be appreciated that the portable communications devices (e.g., 100, 200, 300, 500, etc.) of the present disclosure can also satisfy ESD standards as necessary without compromising the ESD protection or antenna performance. For example, the portable communications devices (e.g., 100, 200, 300, 500, etc.) can satisfy such ESD standards as International Electrotechnical Commission (IEC) standard 61000-4-2, which requires protecting against a +−8 kV contact discharges according to the Human Body Model (HBM).

It should further be appreciated that portable communications devices (e.g., 100, 200, 300, 500, etc.) of the present disclosure can also satisfy RSE standards as necessary without compromising the ESD protection or antenna performance. For example, the portable communications devices (e.g., 100, 200, 300, 500, etc.) can satisfy such RSE standards as 47 CFR 15.209 (FCC regulation that requires all measured radiated harmonics up to, and including, the tenth (or up to 40 GHz, whichever is lowest) to be below 54 dBuV/m at 3 meters distance); European Telecommunications Standards Institute (ETSI) standards (ETSI EN 300 609 that requires −30 dBm Effective Isotropic Radiated Power (EIRP) or 1.83 mV/m at 3 meters distance); etc. In this paragraph, dBuV/m refers to the decibel ratio referenced to one a microvolt per meter. An exemplary embodiments disclosed herein may be used as a lossless distributed filter for internal active FM half-loop and/or monopole antennas.

In addition, exemplary embodiments of the inventors' antenna assemblies may also be useful in portable communication devices in which radiators are re-used by complementary systems (e.g., Bluetooth, wireless local area network (WLAN), a global positioning system (GPS), Wideband Code Division Multiple Access (WCDMA), etc) depends on this solution. As explained above, portable communications devices operable for providing multiple different modes of operation are becoming increasingly prevalent. But the wireless modes used by conventional devices can cause mutual interference between modes of operation, which interference can significantly inhibit the operational effectiveness of these devices. As disclosed herein, exemplary embodiments of the inventors antenna assemblies' generally include an electronics protection system operable for filtering cross-talk and/or for protecting against electrostatic discharge and/or for suppressing radiated spurious emissions. Accordingly, exemplary embodiments include a multi-purpose circuit solution disposed or sandwiched between a high-impedance radiator and a high-impedance amplifier, and which may provide one or more of the following features:
Prevents (or at least inhibits) high power high frequency signals from reaching the low noise amplifier. As recognized by the inventors hereof, primary sources of cross-talk are co-located cellular antennas. In particular, GSM-systems (GSM 850/900/1800/1900) are important due to their high-power (+33 dBm at 850/900) and use of TDMA (Time Division Multiple Access) with harmonic-rich (audible) 217 Hz pulses; and/or
Prevents (or at least inhibits) harmonic signals (e.g., 2xf₀, 3xf₀, etc, where f0 is the carrier frequency of, for example, GSM 850/900/1800/1900, etc.) created by diodes (e.g., 116, 118, 216, 218, 316, 516, 518, etc.) from being re-radiated by the radiator (e.g., 106, 206, 306, 506, etc.) which re-radiation would otherwise violate spectral masks (and thus fail type approval); and/or
Filters and clamps ESD voltages, such as +−8 kV associated with the Human Body Model (HBM).

### EXAMPLES

The following examples are merely illustrative, and do not limit this disclosure in any way.

### Example 1

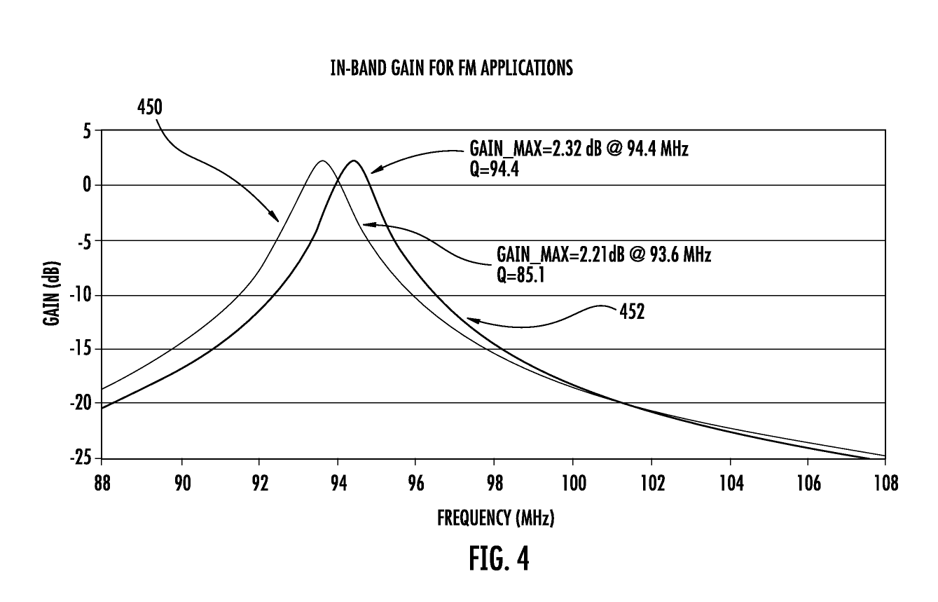

In one example, in-band gain for FM applications was evaluated for two antenna assemblies, one antenna assembly having an electronics protection system according to the present disclosure and one antenna assembly not having such an electronics protection system. Gain for the antenna assembly having the electronics protection system is indicated by line graph 450, and gain for the antenna assembly not having such an electronics protection system is indicated by line graph 452. As shown in FIG. 4, negligible (if any) degradation to performance of the antenna assembly occurs by including the electronics protection system. For example, the antenna assembly not having the electronics protection system exhibited a max gain of about 2.32 decibels (dB) at a frequency of about 94.4 megahertz (MHz) (with a Q-factor of about 94.4), and the antenna assembly having the electronics protection system exhibited a max gain of about 2.21 dB at a frequency of about 93.6 MHz (with a O-factor of about 85.1).

### Example 2

In another example, contact discharges (e.g., ESD contact discharges, etc.) were applied to two antenna assemblies, one antenna assembly having an electronics protection system according to the present disclosure and one antenna assembly not having such an electronics protection system. The antenna assembly having the electronics protection system (e.g., an amplifier of the antenna assembly, etc.) was able to withstand a greater than 8 kV contact discharge (e.g., according to HBM standards, etc.), while the antenna assembly not having the electronics protection system was able to withstand only a 200 volt (V) contact discharge (e.g., according to HBM standards, etc.).

Example embodiments are provided so that this disclosure will be thorough, and will fully convey the scope to those who are skilled in the art. Numerous specific details are set forth such as examples of specific components, devices, and operational methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. Method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on”, “engaged to”, “connected to” or “coupled to” another element or layer, it may be directly on, engaged, connected or coupled to the other element or layer, or intervening elements or layers may be present. In contrast, when an element is referred to as being “directly on,” “directly engaged to”, “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

The disclosure herein of particular values and particular ranges of values for given parameters are not exclusive of other values and ranges of values that may be useful in one or more of the examples disclosed herein. Moreover, it is envisioned that any two particular values for a specific parameter stated herein may define the endpoints of a range of values that may be suitable for the given parameter. The disclosure of a first value and a second value for a given parameter can be interpreted as disclosing that any value between the first and second values could also be employed for the given parameter. Similarly, it is envisioned that disclosure of two or more ranges of values for a parameter (whether such ranges are nested, overlapping or distinct) subsume all possible combination of ranges for the value that might be claimed using endpoints of the disclosed ranges.

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

What is claimed is:

1. An antenna assembly comprising:
an antenna element;
an amplifier; and
an electronics protection system coupled between the antenna element and the amplifier, the electronics protection system including:
first and second inductors disposed in series between the antenna element and the amplifier; and
first and second diodes coupled to ground and disposed between the first and second inductors;
whereby during operation of the antenna assembly, the electronic protection system is configured to be operable for filtering cross-talk, for protecting against electrostatic discharge, and for suppressing radiated spurious emissions generated by the first and second diodes from being radiated by the antenna element.

2. The antenna assembly of claim 1, wherein:
the first and second diodes are configured to short unwanted voltages associated with electrostatic discharge to ground;
the first inductor is configured to suppress unwanted high frequency signals from reaching the first and second diodes and to suppress unwanted spur harmonics generated by the first and second diodes from being radiated by the antenna element; and
the second inductor is configured to suppress unwanted high frequency signals from reaching an input of the amplifier.

3. The antenna assembly of claim 1, wherein the first and second inductors are configured to have parasitic capacitance.

4. The antenna assembly of claim 1, wherein the first and second diodes include anti-parallel diodes coupled in shunt without any intervening inductors or capacitors between the anti-parallel diodes.

5. The antenna assembly of claim 1, wherein the antenna element is a high-impedance antenna element at FM frequencies, and the amplifier is a high-impedance low noise amplifier at FM frequencies, such that the electronics protection system is thereby bound on both sides by said high-impedance components within an FM operating frequency band of the antenna assembly.

6. The antenna assembly of claim 1, wherein the first and second inductors are disposed in high impedance nodes of the antenna assembly at FM frequencies, whereby the first and second inductors' impact on noise properties of the amplifier is effectively cancelled, the first and second inductors each have an inductance operation value within a range of 50 nanoHenries (nH) to about 100 nH, and/or the first and second inductors are operable for reducing radiated harmonics without significantly affecting antenna efficiency due to placement in said high impedance nodes.

7. The antenna assembly of claim 1, wherein:
the antenna assembly is operable over multiple frequency bandwidths including the GSM and Bluetooth operating frequency bandwidths; and
the electronics protection system is operable to:
filter cross-talk including cross-talk associated with GSM and Bluetooth interactions;
protect against electrostatic discharge including protection against human body model pulses of upwards of about 8 kilovolts (kV) discharged at the antenna element; and
suppress radiated spurious emissions, including prevention of harmonic signals created by the first and second diodes from being radiated by the antenna element.

8. The antenna assembly of claim 1, wherein:
the antenna assembly is operable over multiple frequency bandwidths including the FM and Bluetooth operating frequency bandwidths; and
the electronics protection system is operable to filter cross-talk, protect against electrostatic discharge, and suppress radiated spurious emissions, without significantly compromising or negatively impacting antenna performance, without the first and second diodes significantly affecting Bluetooth efficiency, and/or without Bluetooth cross-talk significantly affecting FM sensitivity.

9. The antenna assembly of claim 1, wherein:
the antenna element includes a half-loop antenna element; and
the antenna assembly further comprises a matching capacitor disposed on a side of the first inductor opposite that of the first and second diodes, whereby the matching capacitor is operable for providing impedance matching and forming high impedance and parallel resonance with the half-loop antenna element.

10. The antenna assembly of claim 1, wherein:
the antenna element includes a monopole antenna element; and
the antenna assembly further comprises a matching inductor disposed on a side of the first inductor opposite that of the first and second diodes, whereby the matching inductor is operable for providing impedance matching and forming high impedance and parallel resonance with the monopole antenna element.

11. The antenna assembly of claim 1, wherein the first and second inductors are coupled between the antenna element and the amplifier, such that the first inductor is adjacent the antenna element without any intervening components between the first inductor and the antenna element and such that the second inductor is adjacent the amplifier without any intervening components between the second inductor and the antenna element.

12. The antenna assembly of claim 1, wherein:
the antenna assembly is operable over multiple frequency bandwidths including the FM and GSM 850/900/1800/1900 operating frequency bandwidths;
the first inductor comprises a 56 nH inductor having a self-resonance close to GSM 1800/1900 Tx bands, and which is operable for suppression of GSM 1800/1900 cross-talk while suppressing harmonics of GSM 850/900 created by the first an second diodes from being radiated by the antenna element;
the second inductor comprises a 100 nH inductor having a self-resonance close to GSM 850/900 Tx bands, and which is operable for suppression of GSM 850/900 cross-talk; and
the electronics protection system is operable for filing and clamping electrostatic discharge voltages while being transparent or low impedance at FM frequencies.

13. The antenna assembly of claim 1, wherein the antenna element includes one or more of:
electrically short monopole;
electrically short monopole resonated by a shunt inductor;
electrically short half-loop resonated by a shunt capacitor;
electrically short monopole resonated by a shunt LC resonator;
electrically short monopole resonated/loaded/reactance compensated by a half-loop radiator; and/or
electrically short half-loop resonated/loaded/reactance compensated by a monopole.

14. The antenna assembly of claim 1, wherein:
the electronics protection system is configured to be operable for suppressing radiated spurious emissions associated with harmonic frequency content generated by non-linearities in the first and second diodes caused by GSM and Bluetooth interactions from being radiated by the antenna element; and/or
the electronics protection system consists only of the first and second inductors and the first and second diodes; and/or
the antenna assembly further comprises a frequency modulation receiver.

15. The antenna assembly of claim 1, further comprising first and second capacitors coupled to the respective first and second inductors, and providing parasitic capacitance.

16. A portable communications device including the antenna assembly of claim 1.

17. An electronics protection system suitable for an antenna assembly of a portable communications device and operable for filtering cross-talk, protecting against electrostatic discharge, and suppressing radiated spurious emissions when coupled between an antenna element and an amplifier of the antenna assembly, the electronics protection system comprising:
first and second inductors disposed in series and configured to have parasitic capacitance;
first and second anti-parallel diodes coupled in shunt and disposed between the first and second inductors, the first and second anti-parallel diodes configured to short unwanted voltages associated with electrostatic discharge to ground;
wherein:
the electronics protection system is configured such that when coupled between the antenna element and the amplifier,
the first inductor is adjacent the antenna element and the second inductor is adjacent the amplifier;
the first inductor is configured to suppress unwanted high frequency signals from reaching the first and second anti-parallel diodes and to suppress unwanted spur harmonics generated by the first and second anti-parallel diodes from being radiated by the antenna element; and
the second inductor is configured to suppress unwanted high frequency signals from reaching an input of the amplifier.

18. An antenna assembly including an antenna element, an amplifier, and the electronics protection system of claim 17 coupled between the antenna element and the amplifier such that:
the first and second anti-parallel diodes short unwanted voltages associated with electrostatic discharge to ground;
the first inductor suppresses unwanted high frequency signals from reaching the first and second anti-parallel diodes and suppresses unwanted spur harmonics generated by the first and second anti-parallel diodes from being radiated by the antenna element; and
the second inductor suppresses unwanted high frequency signals from reaching an input of the amplifier.

19. An electronics protection system suitable for an antenna assembly of a portable communications device and operable for filtering cross-talk, protecting against electrostatic discharge, and suppressing radiated spurious emissions when coupled between an antenna element and an amplifier of the antenna assembly, the electronics protection system comprising:
first and second inductors disposed in series; and
first and second anti-parallel diodes coupled in shunt and disposed between the first and second inductors;
whereby when the electronics protection system is coupled between an antenna element and an amplifier:
the first and second anti-parallel diodes are operable to short unwanted voltages associated with electrostatic discharge to ground;
the first inductor is operable to suppress unwanted high frequency signals from reaching the first and second anti-parallel diodes and to suppress unwanted spur harmonics generated by the first and second anti-parallel diodes from being radiated by the antenna element; and
the second inductor is operable to suppress unwanted high frequency signals from reaching an input of the amplifier.

20. The electronics protection system of claim 19, wherein:
the first and second inductors are configured to have parasitic capacitance; and/or
first and second capacitors are coupled to the respective first and second inductors.

21. An antenna assembly including an antenna element, an amplifier, and the electronics protection system of claim 19 coupled between the antenna element and the amplifier, such that the first inductor is adjacent the antenna element ad the second inductor is adjacent the amplifier, and such that:
the first and second anti-parallel diodes short unwanted voltages associated with electrostatic discharge to ground;
the first inductor suppresses unwanted high frequency signals from reaching the first and second anti-parallel diodes and suppresses unwanted spur harmonics generated by the first and second anti-parallel diodes from being radiated by the antenna element; and
the second inductor suppresses unwanted high frequency signals from reaching an input of the amplifier.
